(19) United States
(12) Patent Application Publication
(10) Pub. No.: US 2009/0201422 A1
(43) Pub. Date: Aug. 13, 2009

(54) Automatic input change based on remote control mode change

(75) Inventor: Matthew A. Eshleman, Mount Juliet, TN (US)

Correspondence Address: NIXON & VANDERHYE, PC, 901 NORTH GLEBE ROAD, 11TH FLOOR, ARLINGTON, VA, 22203, US

(73) Assignee: Toshiba America Consumer Products, LLC, Wayne, NY (US)

(21) Appl. No.: 12/318,760

(22) Filed: Jan. 7, 2009

Related U.S. Application Data
(60) Provisional application No. 61/006,341, filed on Jan. 7, 2008.

(51) Int. Cl. H04N 3/27; H04N 5/44

(52) U.S. Cl. 348/554; 348/734; 348/E03.049; 348/E05.096

(57) ABSTRACT

Example systems and methods for switching television inputs involve receiving a remote control input for switching a remote control mode from controlling a first device to controlling a different, second device and automatically generating, in response to the remote control mode switching input, an input switch command for switching an input of the television to an input to which the second device is coupled.

### CROSS-REFERENCE TO RELATED APPLICATION

This application claims the benefit of application No. 61/006,341, filed Jan. 7, 2008, the contents of which are incorporated herein in their entirety.

### BACKGROUND AND SUMMARY

The subject application generally relates to systems and methods in which a video switch connected to multiple devices such as a VCR, DVD player, set top box, etc. automatically switches inputs when a user changes modes on a remote control. For example, when the user presses/selects the “DVD” mode on the remote control, the video switch automatically switches inputs so that video/audio from the DVD input is output from the television.

The example systems and methods for switching television inputs described herein involve receiving a remote control input for switching a remote control mode from controlling a first device to controlling a different, second device and automatically generating, in response to the remote control mode switching input, a switch command for switching an input of the television to an input to which the second device is coupled.

### BRIEF DESCRIPTION OF THE DRAWINGS

FIG. 1 is a highly generalized block diagram of an example television 100 in which the example systems and methods described herein may be implemented.

FIG. 2A provides a more detailed view of example remote control 150 in FIG. 1.

FIG. 2B is a generalized block diagram of remote control 150.

FIG. 3 shows a generalized system block diagram that includes a remote control 302, a video switch 304 and one or more devices 306 connected to the video switch 304.

FIG. 4 shows an example user interface.

### DETAILED DESCRIPTION OF EXAMPLE EMBODIMENTS

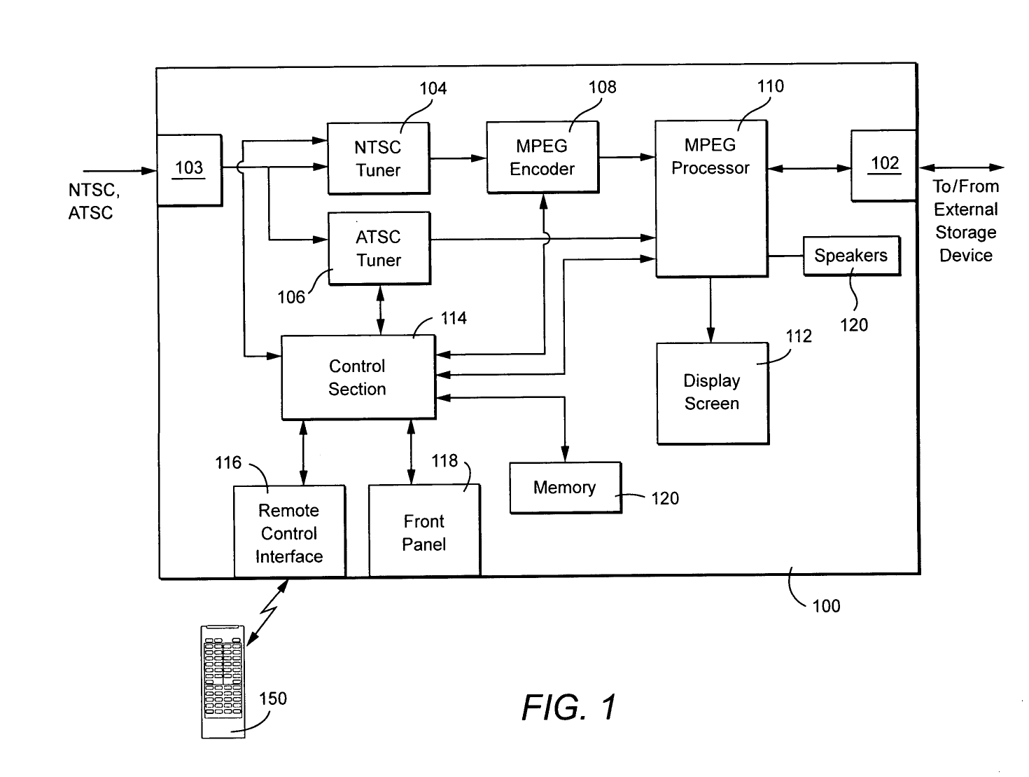

FIG. 1 is a highly generalized block diagram of a television 100 in which the example systems and methods described herein may be implemented. The details of television 100 are provided by way of example only and it will be readily apparent that the systems and methods described herein may be implemented in a wide variety of televisions of different configurations, both analog and digital.

An input 103 of the television receives NTSC and ATSC signals. The NTSC signals are supplied to an NTSC tuner 104 and the ATSC signals are supplied to an ATSC tuner 106. Other inputs (not shown) may also be supplied to the television. For example, the television may receive HDMI signals or the output from a DVD player. The output of NTSC tuner 104 is supplied to an MPEG encoder 108 which MPEG encodes the tuned NTSC signal. The outputs of ATSC tuner 106 and MPEG encoder 108 are supplied to an MPEG AV processor 110. MPEG AV processor 110 processes the MPEG transport stream from the ATSC tuner 106 and/or MPEG encoder 108 and supplies a display signal to display screen 112 and a sound signal to speakers 120. MPEG AV processor 110 also selectively outputs an MPEG transport stream to and receives an MPEG transport stream from an external storage system via interface 102. The external storage system may, for example, include a hard disk drive (HDD) recording device, a DVD recording device, or an HDD/DVD recording device. Generally speaking, MPEG AV processor 110 is a standard processing device used in conventional digital integrated televisions, monitors and set-top box (STB) units that receives MPEG compressed AV data and decompresses and processes the AV data for output via display screen 112 and speakers 120.

A control section 114, including a CPU, for example, controls the overall operations of television 100. In general, control section 114 may include, for example, a microprocessor, a microcontroller, a processor, a controller, an application specific integrated circuit (ASIC), logic circuitry, a state machine and/or combinations thereof. Control section 114 may be supplied with inputs from a user via a remote control interface (e.g., infrared wireless receiver) 116 for a remote control 150 (e.g., an infrared remote control) and front panel keys 118. MPEG AV processor 110 may selectively block output of audio and/or video in accordance with control signals from control section 114.

Memory 120, which may be a combination of volatile and non-volatile semiconductor memory, stores various operating programs and user settings (e.g., rating level(s) set by parents) used by control section 114 to control the operation of television 100. For example, memory 120 may include ROM storing an operating program for execution by the control section 114 to implement the systems and methods described herein. The operating programs may provide for control of tuners 104, 106; control of MPEG AV processor 110 to generate displays for display on display screen 212 and sounds for output via speakers 120; processing of inputs supplied by a user via front panel 118 and/or remote control 150; and the like. Memory 120 may also include SDRAM for use by control section 114 during execution of the operating program.

Television 100 may also be provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to the external storage device via interface 102). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

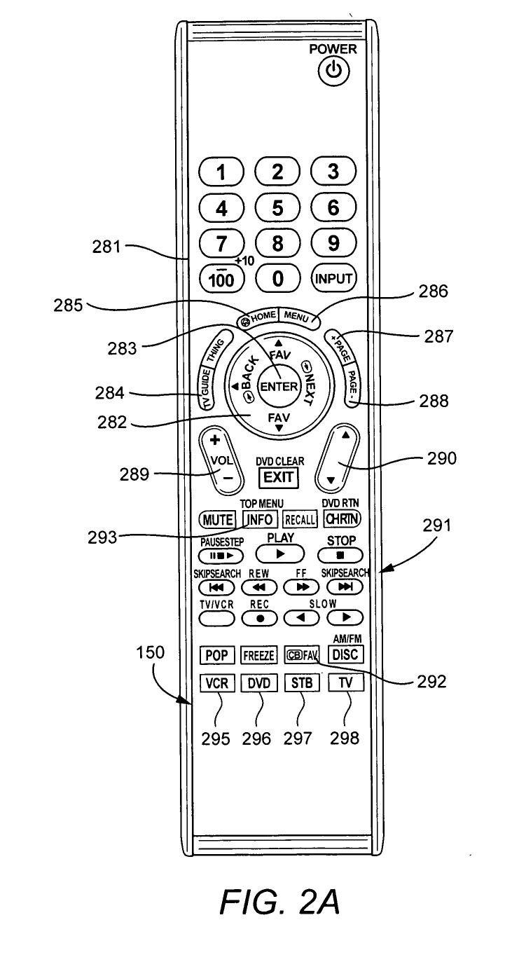

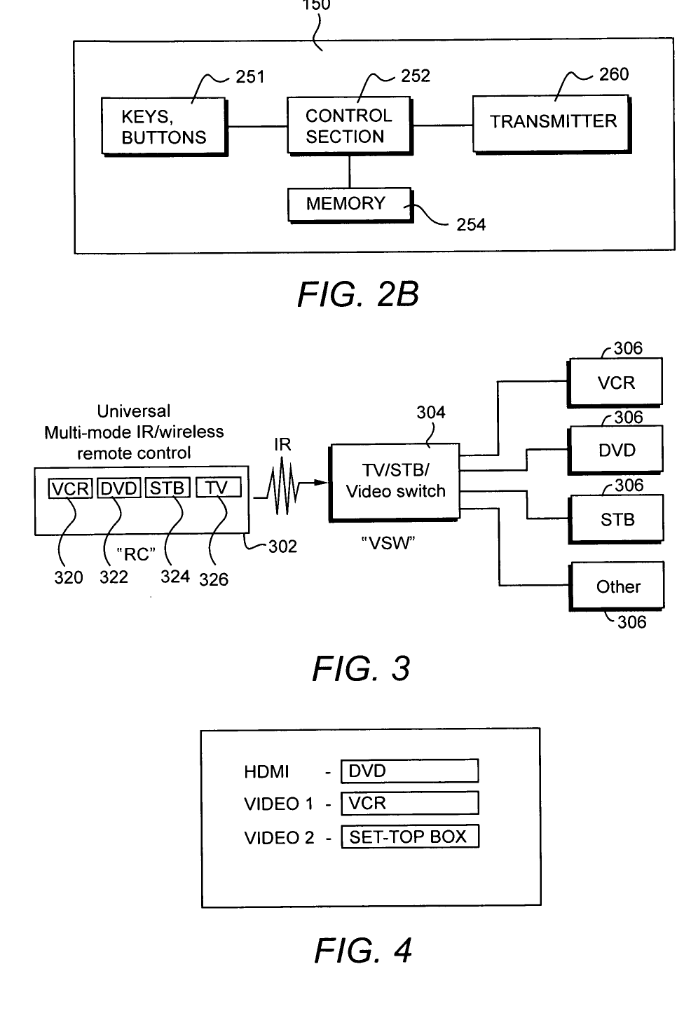

FIG. 2A shows an example layout of keys and buttons for remote control 150. The keys or buttons of remote control 150 may be appropriately labeled to assist the user in selecting a desired function. Alternatively or additionally, television 100 may provide one or more displays that inform the user which key(s) or button(s) should be actuated to input desired commands. Other types of inputs such as voice inputs may also be used to input commands in certain implementations.

Remote control 150 includes a numeric keypad 281 including the numbers 0-9. Keypad 281 also includes a “−/100” key for use in entering channel numbers greater than 100 and a delimiter for separating major and minor channel numbers (e.g., channel 125-3). An “Input” key is provided for use in switching between different inputs to television 100 (e.g., different antennas, different video inputs, different devices connected to the television, etc.). Remote control 150 also includes a navigation switch 282 that provides for up, down, left and right navigation through menus, program guides, and the like. An enter key 283 is also provided. Various keys are provided around part of the periphery of navigation switch 282. A “program guide” key 284 causes a program guide to be displayed. A “home” key 285 causes television 200 to tune to a HOME channel. A “menu” key 286 causes television 200 to display an initial menu screen for accessing various features of television 200. A “Page+” key 287 and a “Page−” key 288 provide for navigation through menus, program guides, etc. A volume up/down key 289 and a channel up/down key 290 permit the user to set the volume level and to select television channels. A DVD/VCR keypad 291 allows the user to control a DVD player and/or a VCR. A “Fav” key 292 accesses a favorite channel feature. An “Info” key 293 can be pressed by a user to access additional information on a particular topic. The remote control also has keys 295, 296, 297 and 298 for changing the mode of remote control 150 so that it can control a VCR, a DVD player, a set-top box (STB) and a television (TV), respectively. Thus, when a user wants to use remote control 150 to control a DVD player, the user presses key 296 and thereafter the remote control can be used to control the DVD player using keypad 291, for example. To then use the remote control to control the television, the user presses key 298 and thereafter the remote control can be used to control the television.

It will of course be appreciated that the function(s) associated with the various keys and buttons of the remote controls described above may vary depending on the state of television 100 (e.g., watching television, moving through menus, making menu selections, etc.). Moreover, the layout of the keys and buttons shown in FIG. 2A is not intended to be limiting in any way and various designs for laying out these keys and buttons may be adopted.

When the viewer presses one of the keys on remote control 150, the key press is detected by a control section 252 (see FIG. 2B) of the remote control. Control section 252 may be implemented as a microprocessor, a microcontroller, logic array, application specific integrated circuit (ASIC), etc., or some combination of those elements. Control section 252 controls a wireless transmitter 260 to send a signal indicative of a pressed key (or keys) to wireless receiver 116 of television 100. Memory 254 of remote control 150 stores control codes used to control the television, DVD player, VCR, etc. In response to pressing of a key or button and in dependence on the mode in which the remote control is set, control section 252 reads out from memory 254 an appropriate code which is sent to the controlled device using transmitter 260. As is well-known, the remote control may be programmed with control codes for controlling numerous devices from various manufacturers and the user can set which control codes are used for a particular controlled device during a set-up operation (e.g., by entering a particular numeric code in dependence on, for example, the type of controlled device and its manufacturer).

As noted above, remote controls are often used to control two or more different devices. For example, a remote control for a television is often configured so that its mode may be changed to permit control of a DVD player, VCR, HDD recorder or other device commonly connected to the television. To change the mode of the remote control, a remote control key (or keys) is pressed. The remote control may include dedicated keys (e.g., a DVD key and/or a VCR key) for this purpose or a series of keypresses involving keys normally having other functions may be used. Thereafter, the remote control can be used to send commands to the DVD player or VCR.

The remote control may be set to control particular equipment because a user wants to view the output from that equipment on the television. Thus, a user setting the remote control to control a DVD player may want to watch a movie on a DVD being played back by the DVD player. However, in order for the DVD player video and audio output to be output on the screen and speakers of the television, the television must be “switched” so that audio/video from the input to which the DVD player is connected is output via the television's screen and speakers. This generally means that the user must then press the input key on keypad 281 one or more times until the television's active input is that input to which the DVD player is connected.

FIG. 3 shows a generalized block diagram for explaining example systems and methods that automatically switch a television's input when the mode of the remote control is switched. The FIG. 3 system includes a remote control 302, a video switch 304 and one or more devices 306 connected to the video switch 304. Remote control 302 is shown as including mode changing switches 320, 322, 324 and 326 for changing the mode of the remote control to control a VCR, a DVD player, a set-top box and a television, respectively. For ease of illustration, the other remote control keys and buttons are not shown in FIG. 3. Generally speaking, video switch 304 may, for example, be a television or set-top box to which devices 306 such as a VCR, DVD player, (another) set-top box and the like may be connected. By way of illustration and without limitation, in the following discussion, video switch 304 is assumed to be a television although, as noted previously, the switch may be also be a set-top box or other device.

Remote control 302 and television 304 are configured so that television 304 automatically switches its inputs when a user changes modes using the remote control. For example, if the user presses (or selects) the DVD mode key 322 on remote control 302, the television automatically switches its active input to process and output video/audio supplied to the television input to which the DVD player is connected. Similarly, if the user presses the VCR mode key 320 on remote control 302, the television automatically switches its active input to process and output video/audio supplied to the input to which the VCR is connected.

To permit this switching, remote control 302 sends a wireless command to television 304, whenever the mode of the remote control is changed by the user. In an example embodiment, a different command is allocated to each mode of the remote control (e.g., DVD, VCR, etc.). Thus, when the DVD mode key 322 is pressed, the control section of the remote control sends a switch command via transmitter 260 to the television for switching its input to the input connected to the DVD player. Control section 114 of television 100 detects and processes the switch command sent by the remote control to switch the input in accordance with the command.

The television may be provided with a user interface, an example of which is shown in FIG. 4, that allows a user to identify which devices are connected to its inputs so that the television responds appropriately when a particular mode change command is received. By way of example and without limitation, the user interface can provide a method for the customer to associate television inputs (e.g., HDMI, Video 1, Video 2, etc.) with the device to which these inputs are connected (e.g., DVD, VCR, Set-Top Box for cable or satellite television, etc.) Information about these devices and corresponding connections of the television inputs may be stored in memory 120, for example. Thus, when the remote control mode is changed to DVD and the DVD mode change command is sent from the remote control to the television, the television input can be automatically switched so that audio and video from the DVD player is output via the screen and speakers of the television.

In short, the systems and methods described herein allow the automatic switching of video switch inputs to user configured inputs when a corresponding mode change command is received from a remote control whose mode is changed to control a particular device.

The various aspects of the systems and methods described herein may be implemented as part of an operating program executed by control section 252 of remote control 150 and as part of an operating program executed by control section 114 of television 100. These programs can, for example, be tangibly embodied or stored on a computer-readable medium such as memory 254 of remote control 150 and memory 120 of television 100. These memories may include magnetic memory, optical memory, semiconductor memory, magneto-optic memory, combinations thereof and the like and may, in some instances, be removable memories. In another example, the program(s) may be available for downloading over the internet so that the program(s) may be delivered via a communication network. Updates may be provided via downloads. Further, a carrier wave may be modulated by a signal representing the corresponding program and an obtained modulated wave may be transmitted, so that the television that receives the modulated wave may demodulate the modulated wave to restore the corresponding program.

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the spirit and scope of the appended claims.

I claim:

1. A method for switching television inputs, the method comprising:
receiving a remote control input for switching a remote control mode from controlling a first device to controlling a different, second device; and
automatically generating, in response to the remote control mode switching input, an input switch command for switching an input of the television to an input to which the second device is coupled.

2. A remote control comprising:
an input device for inputting a mode switching command for switching a remote control mode from controlling a first device to controlling a different, second device;
a processing system for automatically generating an input switch command for switching an input of a television to an input to which the second device is coupled; and
a transmitter for transmitting the input switch command to the television.

3. A computer-readable medium having stored therein program instructions for a method for switching television inputs, the method comprising:
receiving a remote control input for switching a remote control mode from controlling a first device to controlling a different, second device; and
automatically generating, in response to the remote control mode switching input, an input switch command for switching an input of the television to an input to which the second device is coupled.

4. A remote control comprising the computer-readable medium according to claim 3.

5. A television comprising:
an interface configured to receive inputs associating television inputs with particular devices;
a memory storing data based on the inputs; and
a processing system, responsive to a mode signal from a remote control indicative of a particular device to be controlled by the remote control, for accessing the memory and switching an input of the television to that input which is connected to the particular device.

6. The television according to claim 5, wherein the mode signal is indicative of a DVD device to be controlled by the remote control.

7. The television according to claim 5, wherein the mode signal is indicative of a set-top box device to be controlled by the remote control.

8. The television according to claim 5, wherein the mode signal is indicative of a VCR device to be controlled by the remote control.
